(19) United States
(12) Patent Application Publication
(10) Pub. No.: US 2014/0300484 A1
(43) Pub. Date: Oct. 9, 2014

(54) Emergency Entry / Egress Door Chock (also referred to as the "3EDC")

(71) Applicant: Shamus A. Martin, Saxtons River, VT (US)

(72) Inventor: Shamus A. Martin, Saxtons River, VT (US)

(21) Appl. No.: 13/745,791

(22) Filed: Apr. 8, 2013

(51) Int. Cl. G08B 5/36

(52) U.S. Cl. CPC G08B 5/36
USPC 340/815.45

(57) ABSTRACT

The 3EDC System is comprised of three (one green, one yellow, and one red) multi-purpose, color coded, pulsating l.e.d. door chocks.

The color scheme provides departments with the flexibility to develop their own methods of deployment while maintaining a basic and intuitive tracking and/or tagging strategy.

The 3EDC's can be used to chock left or right opening doors in residential, public, and commercial buildings. The notches located on each side of the chock enable Firefighters to chock larger doors such as those found in schools and hospitals, at the hinges.

The 3EDC's can be mounted at a variety of locations on personal protective equipment via the clip on the bottom of each chock. It is also designed for users to grasp, engage, and place in one motion.

1. The device is comprised of the following:
1×Blinking LED circuit encapsulated behind a retro-reflective lens
1×chock mold
1×belt clip
This is an all-inclusive, singular device with no current options or accessories.

2. This is a single path, dc powered, series circuit controlled with one switch that is incorporated internally into the chock.

3. The 3EDC System is comprised of three (one green, one yellow, and one red) multi-purpose, green, yellow, and red color coded, pulsating l.e.d. door chocks.

### FIGURE/ITEM LIST

### Figures

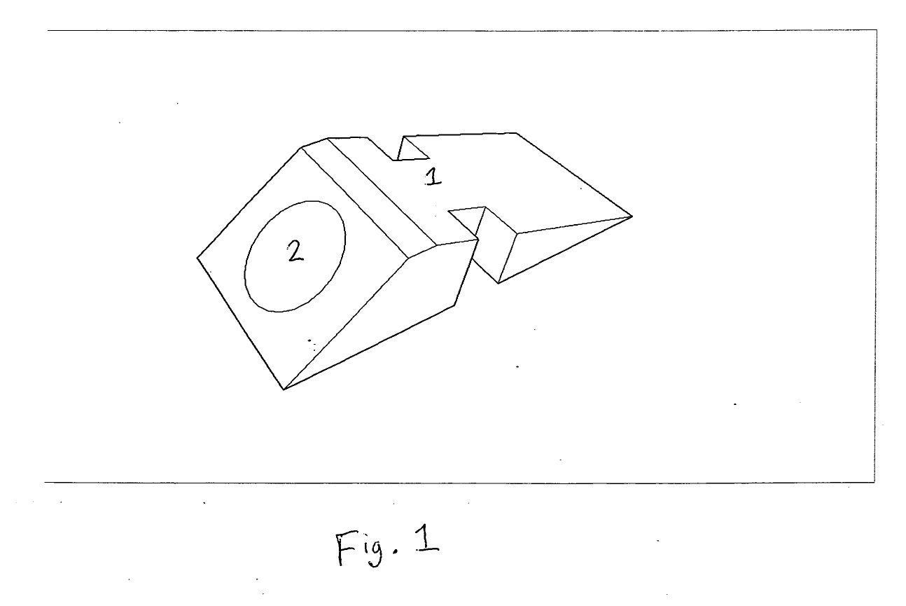

FIG. 1—Top View

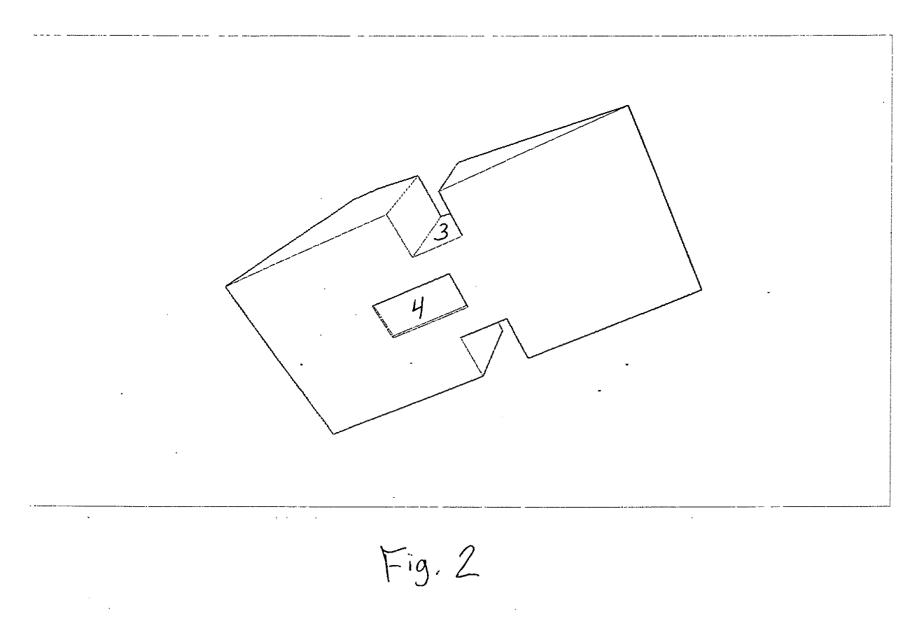

FIG. 2—Bottom View

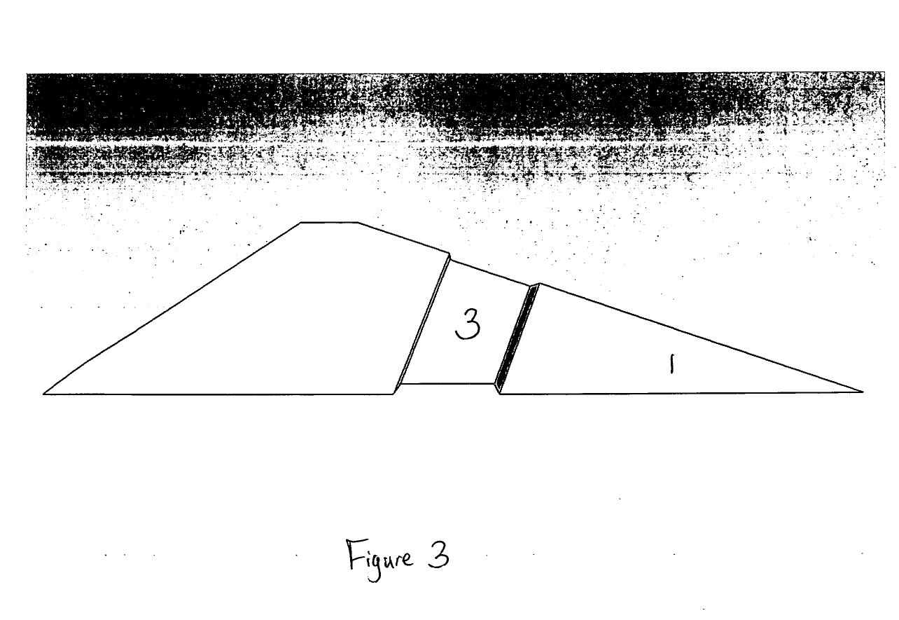

FIG. 3—Left Side

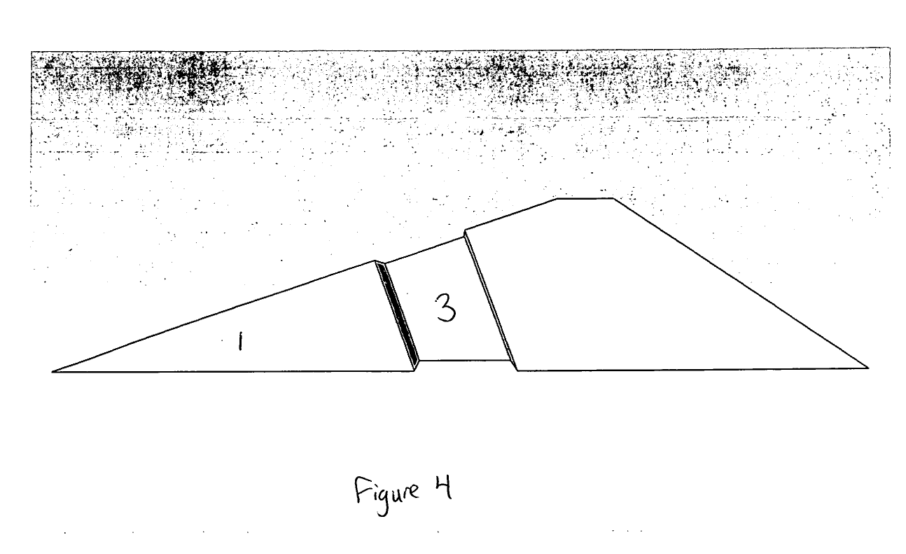

FIG. 4—Right Side

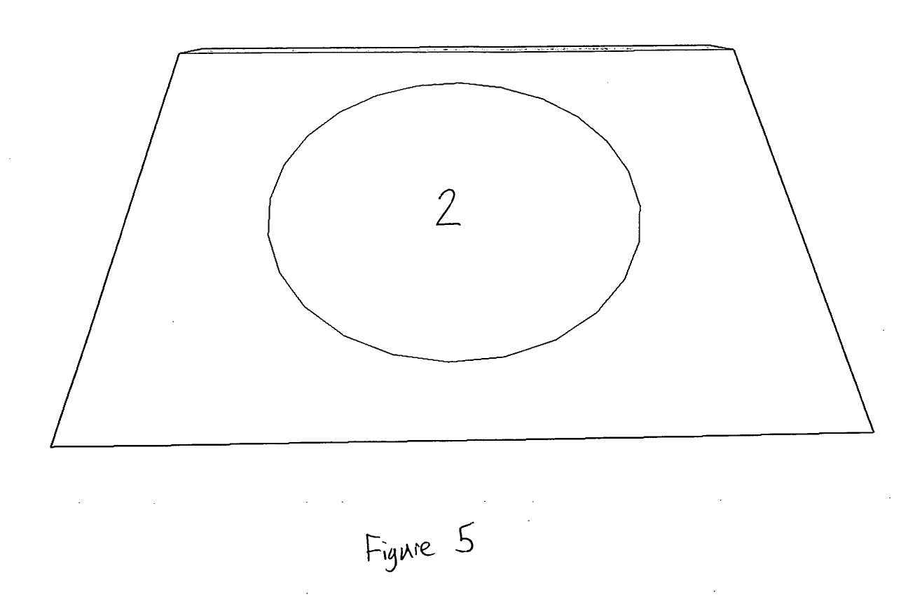

FIG. 5—Frontal View

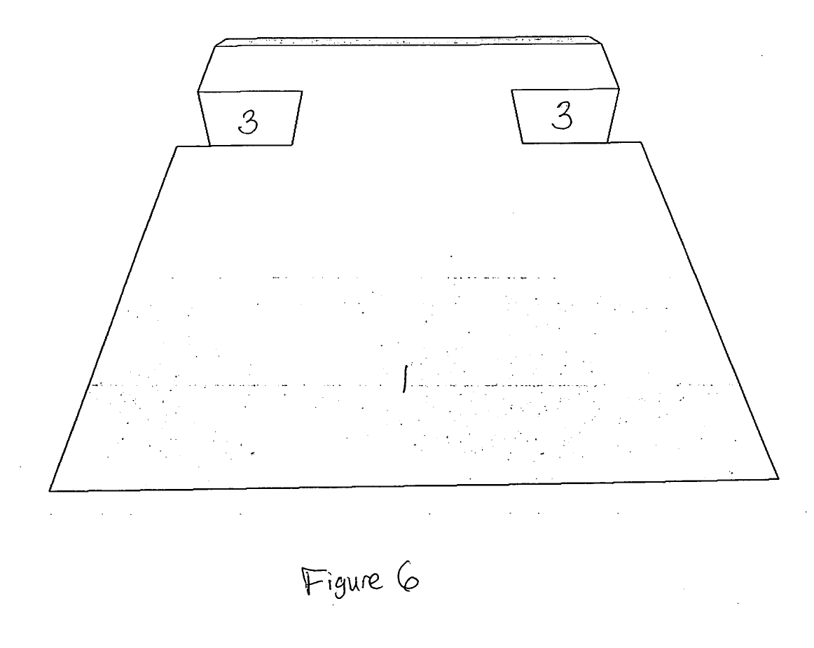

FIG. 6—Rear View

### Items

Item #1—Chock Body

Item #2—Retroreflective lens/Blinking LED Circuitry

Item #3—Hinge Notch

Item #4—Clip Recess

1. The present invention relates to a color coded blinking door chock used for tracking and/or tagging by and for emergency services personnel.

2. The device is comprised of the following:
1×Blinking LED circuit encapsulated behind a retro-reflective lens
1×chock mold
1×belt clip
This is an all-inclusive, singular device with no current options or accessories.

3. This is a single path, dc powered, series circuit controlled with one switch that is incorporated internally into the chock.

4. The 3EDC System is comprised of three (one green, one yellow, and one red) multi-purpose, color coded, pulsating l.e.d. door chocks.

5. The color scheme provides departments with the flexibility to develop their own methods of deployment while maintaining a basic and intuitive tracking and/or tagging strategy.

6. The 3EDC's can be used to chock left or right opening doors in residential, public, and commercial buildings. The notches located on each side of the chock enable Firefighters to chock larger doors such as those found in schools and hospitals, at the hinges.

7. The 3EDC's can be used as a tracking mechanism in that the green chock can be placed at the initial point of entry, a yellow and the second, and red at the third thus allowing personnel to re-trace the entrance path.

8. The 3EDC's can be used to tag areas as being safe (green chock), actively investigating (yellow chock), and unsafe (red chock).

9. The 3EDC's can be mounted at a variety of locations on personal protective equipment via the clip on the bottom of each chock. It is also designed for users to grasp, engage, and place in one motion.
Possible Uses
Interior search and rescue
Tracking
The 3EDC's can be used to track how deep firefighters are within a building. Using this method firefighters place a green chock at the initial point of entry, a yellow at the secondary point such as a bedroom door within a house, and a red chock at the third point such as a bathroom within a master bedroom. This method allows firefighters to exit the way they came and assists Rapid Intervention Teams follow the trail of firefighters should a may day be called.
Tagging
The 3EDC System can also be used to tag rooms. Green chocks could indicate areas that have been cleared, yellow chocks may indicate areas that are in the process of being checked, and red chocks could indicate areas that are not safe to enter.
Hazmat
Similar to the tagging method used in interior search and rescue operations, the 3EDC's can also be used for tagging safe or unsafe areas in Hazmat situations as well.
Conclusion
The 3EDC System is the only logical tracking/tagging system currently available to emergency services personnel.
